(19) United States
(12) Patent Application Publication
(10) Pub. No.: US 2013/0157239 A1
(43) Pub. Date: Jun. 20, 2013

(54) AUGMENTED REALITY TELE-MENTORING (ART) PLATFORM FOR LAPAROSCOPIC TRAINING

(71) Applicant: Board of Regents of the Nevada System of Higher Education, on behalf of the Universty of Nevada, Reno, NV (US)

(72) Inventor: Michael Russo, Las Vegas, NV (US)

(73) Assignee: BOARD OF REGENTS OF THE NEVADA SYSTEM OF HIGHER EDUCATION, ON BEHALF OF THE UNIVERSITY OF NEVADA, Reno, NV (US)

(21) Appl. No.: 13/715,113

(22) Filed: Dec. 14, 2012

Related U.S. Application Data
(60) Provisional application No. 61/576,928, filed on Dec. 16, 2011.

(51) Int. Cl. G09B 23/28

(52) U.S. Cl. CPC G09B 23/28
USPC 434/262

(57) ABSTRACT

Disclosed herein are methods and systems for tele-mentoring, such as for laparoscopic training. In one example, a system includes a mentor environment and a trainee environment wherein the mentor environment is coupled to the trainee environment so that an image of the mentor laparoscopic instruments is superimposed on the trainee laparoscopic instruments allowing a mentor to provide real-time audible and visual guidance to a trainee. The mentor environment can include a training laparoscopic box simulator with a camera and mentor instructional laparoscopic instruments; a mentor audio/visual processor coupled to the mentor training laparoscopic box simulator; a mentor microphone coupled to the computing device; and a mentor display coupled to at least the computing device. The trainee environment can include a trainee system with trainee laparoscopic instruments and a video device, such as a camera; a trainee microphone coupled to the trainee system; and a trainee display coupled to the mentor environment.

### CROSS REFERENCE TO RELATED APPLICATION

This application claims the benefit of U.S. Provisional Patent Application No. 61/576,928, filed Dec. 16, 2011, which is incorporated herein by reference in its entirety.

### FIELD

This disclosure concerns tele-mentoring, and in particular, systems and methods of tele-mentoring for laparoscopic training or procedures.

### BACKGROUND

Tele-mentoring represents a new and exciting way for surgeons to be guided by experts intraoperatively from a remote location such as an office, or even over long-distances. It bridges the physical distance between patients in remote areas and medical specialists around the world. A tele-mentoring platform traditionally included an audio-visual communication feed wherein the mentor could see the operative suite on a video monitor and provide audio feedback to guide the operating surgeon. More recently, with the advent of robotic surgery, tele-mentoring has evolved. A tele-mentorer can have a live video feed of the operative field as well as one to multiple robotic arms to control in the operative field. Nonetheless, most operations are performed using laparoscopy, and the addition of a robotic tele-mentoring platform confers an astronomical cost that may not be feasible for many institutions, and for routine procedures.

### SUMMARY

Disclosed herein are systems and methods for tele-mentoring, such as tele-mentoring in a laparoscopic surgery environment. The disclosed methods and systems allow a mentor, such as a surgical mentor (e.g., a trained expert surgeon) to visually and/or audibly coach the learner in either a training or operative environment.

In some examples, a disclosed tele-mentoring system comprises a mentor environment, comprising a mentor training lap box simulator comprising a camera and mentor instructional laparoscopic instruments; a computing device comprising a mentor audio/visual (A/V) processor coupled to the mentor training lap box simulator; a mentor microphone coupled to the computing device; and a mentor display coupled to at least a computing device, thereby forming a mentor environment; and a trainee environment, comprising a trainee system comprising trainee laparoscopic instruments and a video device; a trainee microphone coupled to the trainee system; and a trainee display coupled to the mentor environment thereby forming a tele-mentoring system for use during laparoscopic procedures wherein the mentor environment is coupled to the trainee environment so that an image of the mentor instructional laparoscopic instruments is superimposed on the trainee laparoscopic instruments allowing a mentor to provide real-time audible and visual guidance to a trainee.

In some examples, a disclosed method for tele-mentoring comprises receiving a video signal from a trainee system; receiving video input from a mentor training lap box simulator comprising a camera; receiving audio input from a mentor microphone; combining the mentor training lap box video, mentor audio, and trainee video to generate hybrid audio/visual (A/V) signal so that the video signal from the mentor training lap box is superimposed on the trainee video; displaying the hybrid signal at a mentor display; sending the hybrid signal to the trainee system for display at a trainee system display; and receiving/sending audio and visual data between the two systems to allow real-time audible and visual guidance to be provided.

The foregoing and other features and advantages of the disclosure will become more apparent from the following detailed description, which proceeds with reference to the accompanying figures.

### BRIEF DESCRIPTION OF THE DRAWINGS

FIG. 1 is a schematic of an embodiment of a disclosed tele-mentoring system.

FIG. 2 is a flow chart of an exemplary method for tele-mentoring of a laparoscopic procedure.

FIG. 3A is a graph illustrating learning curves using an exemplary ART platform and traditional training.

FIG. 3B is a graph illustrating learning curves using an exemplary ART platform and traditional training for the first four trials only.

FIG. 4 is a schematic of an exemplary computing environment for performing aspects of the disclosed methods.

### DETAILED DESCRIPTION OF SEVERAL EMBODIMENTS

### I. Overview of Several Embodiments

Disclosed herein is a tele-mentoring system, including a mentor environment, comprising: a mentor training lap (laparoscopic) box simulator comprising a camera and mentor instructional laparoscopic instruments; a computing device comprising an audio/visual (A/V) processor coupled to the mentor training laparoscopic box simulator; a mentor microphone coupled to the computing device; and a mentor display coupled to the aforementioned computing device, thereby forming a mentor environment; and a trainee environment, including a trainee system, comprising trainee laparoscopic instruments, and a video device; a trainee microphone coupled to the trainee system; and a trainee display coupled to the mentor environment thereby forming a tele-mentoring system for use during laparoscopic procedures wherein the mentor environment is coupled to the trainee environment so that an image of the mentor instructional laparoscopic instruments is superimposed on the trainee laparoscopic monitor allowing a mentor to provide real-time audible and visual guidance to a trainee.

In some embodiments, the tele-mentoring system includes a mentor environment that is portable/mobile.

In some embodiments, the tele-mentoring system includes a mentor environment in a remote location.

In some embodiments, the tele-mentoring system includes a mentor environment that is coupled to the trainee environment by a network, such as a Local Area Network (LAN), Wide Area Network (WAN) or the internet.

In some embodiments, the tele-mentoring system utilizes a wireless communication network to couple the mentor environment to the trainee environment.

In some embodiments, the tele-mentoring system includes a wired communication network for coupling the mentor environment to the trainee environment.

In some embodiments, the tele-mentoring system includes a mentor environment that uses green screen technology for superimposition of images/data.

In some embodiments, the tele-mentoring system includes a laparoscopic training box further comprising chroma key compositing to remove background color of the video generated by the mentor camera.

In some embodiments, the tele-mentoring system includes a computing device with an A/V processor further comprising a filter for filtering a visual signal and a signal mixer for creating a hybrid image.

In some embodiments, methods for tele-mentoring include receiving a trainee video signal from a trainee system; receiving a mentor video signal from a mentor training box simulator; receiving a mentor audio signal from a mentor microphone; generating a hybrid video signal based on the mentor video signal and the trainee video signal to generate a hybrid video signal; displaying the hybrid video signal at a mentor display; and sending the hybrid video signal and the audio signal to the trainee system, wherein the combining and the sending occurs in real time to allow for real-time audible and visual guidance of a trainee by its mentor is facilitated.

In some embodiments of the method, the mentor video signal comprises an image of mentor instruments with a background having substantially uniform background color.

In some embodiments of the method, the generating comprises: removing the background color of the mentor video signal using chroma key compositing to generate a filtered mentor video signal, and combining the filtered mentor video signal to the trainee video signal to generate the hybrid video signal.

In some embodiments, a method for tele-mentoring is a method for tele-mentoring for a laparoscopic procedure.

In some embodiments, a method for tele-mentoring includes a mentor training laparoscopic box simulator comprising laparoscopic instructional instruments.

In some embodiments, the mentor training laparoscopic box simulator is portable/mobile.

In some embodiments, the mentor training laparoscopic box is at a remote location.

In some embodiments, the mentor training laparoscopic box simulator is coupled to the trainee system by a network, such as a Local Area Network (LAN), Wide Area Network (WAN) or the internet.

In some embodiments, the mentor training lap box simulator is coupled to the trainee system by a network comprising wireless communication.

In some embodiments, the method for tele-mentoring comprises filtering the mentor training laparoscopic box video and trainee video prior to combining the mentor training laparoscopic box video, mentor audio, and trainee video to generate hybrid audio/visual (A/V) signal.

In some embodiments, the method for tele-mentoring comprises filtering the mentor training laparoscopic box video by using chroma key compositing to remove the background color in the video signal from the mentor box.

In some embodiments, the method for tele-mentoring utilizes a mentoring training laparoscopic box simulator comprising green screen technology.

### II. Systems and Methods for Tele-Mentoring

Disclosed herein are systems and methods for tele-mentoring, such as tele-mentoring in a laparoscopic surgery environment. The disclosed systems and methods allow a mentor, such as a surgical mentor (e.g., a trained expert surgeon) to visually and/or audibly coach the learner, such as a resident or medical student, in either a training or operative environment.

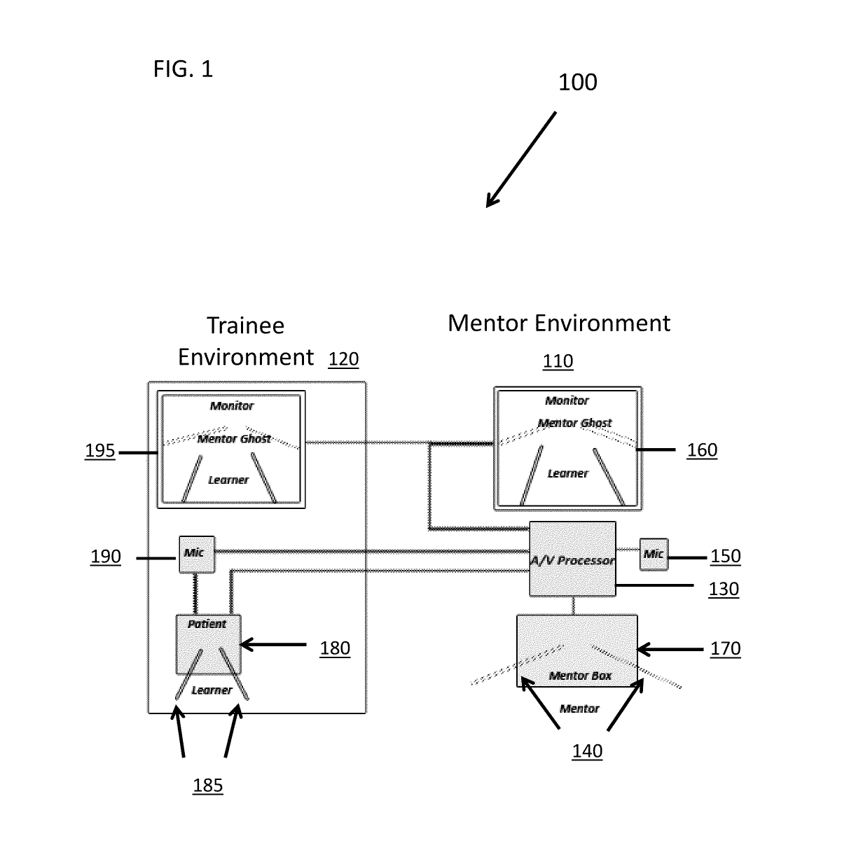

FIG. 1 provides an exemplary tele-mentoring system 100. Tele-mentoring system 100 comprises a mentor environment 110 and a trainee environment 120. In some examples, mentor environment 110 comprises a mentor training box simulator 170 including a device which allows the movement/actions of the mentor to be visualized and/or captured, such as with a camera, and one or more instructional instruments, such as laparoscopic instruments (two shown collectively referred to as 140). In some examples, a mentor training box simulator comprises one or more mentor instructional instruments which are similar, if not identical, to those to be used in the trainee environment. In some examples, instruments identical to those being used in the operating room are introduced into the simulator box and operated as if performing surgery.

In some examples, mentor environment 110 further comprises additional devices such as a mentor microphone 150, a mentor display 160 (such as a mentor display screen), and/or a mentor A/V processor 130 (such as a mentor A/V processor within a computing device) for allowing the movements/actions as well as speech of the mentor to be provided to the trainee environment. For example, mentor A/V processor 130 can be coupled to mentor training box simulator 170, mentor microphone 150 coupled to a computing device containing mentor A/V processor 130 and mentor display 160, such as mentor display screen, coupled to mentor A/V processor 130. In some examples, mentor microphone 150 is a two-way microphone speaker. In some examples, the mentor environment 110, such as the computer device comprising A/V processor 130, further comprises a filter for filtering the visual signals and a signal mixer for creating a hybrid image. In some examples, mentor training box simulator 170 is configured with green-screen technology for superimposition of images/data. In some examples, the A/V processor 130 further uses chroma key compositing (also referred to as color keying, color-separation overlay, green-screen and blue-screen) to remove the background of the video signal from the mentor training box simulator 170 to allow images of the mentor instructional instruments 140 to be superimposed on the video signal of the trainee system 180. It is contemplated that any device known to one of ordinary skill in the art can be employed to visualize and/or process the movements/actions of the mentor.

In some embodiments, trainee environment 120 comprises a trainee system 180 including one or more trainee instruments, such as a set of laparoscopic instruments (two shown and collectively referred to as 185) and an image device which allows the trainee instruments and surrounding image field (video of the trainee system) to be provided to the mentor environment. In some examples, a trainee microphone 190 is coupled to trainee system 180 and a trainee display 195 is coupled to mentor environment 110 to result in tele-mentoring system 100 which allows an image of mentor instructional instruments to be superimposed on video of the trainee system, allowing a mentor to provide real-time audible and visual guidance to a trainee.

In some examples, the mentor environment is portable/mobile. In some examples, the mentor environment is located in a first room and the trainee environment is located in a second room. For example, the trainee environment is an operating room and the mentor environment is a room adjacent to the operating room, or a room in the same building as the operating room. In some examples, the mentor environment is located at a first location and the trainee environment is located at a second location. For example, the trainee environment is an operating room and the mentor environment is a remote office.

In some examples, the mentor environment is coupled to the trainee environment by a network, such as a Local Area Network (LAN), Wide Area Network (WAN) or the internet. In some examples, the mentor environment is coupled to the trainee environment by a wireless communication network. In some examples, the mentor environment is coupled to the trainee environment by a wired communication network.

In some examples, the system does not include a robotic arm.

It is contemplated that the disclosed tele-mentoring system may be used to tele-mentor any procedure, such as any surgical or training procedure, as desired by one of ordinary skill in the art.

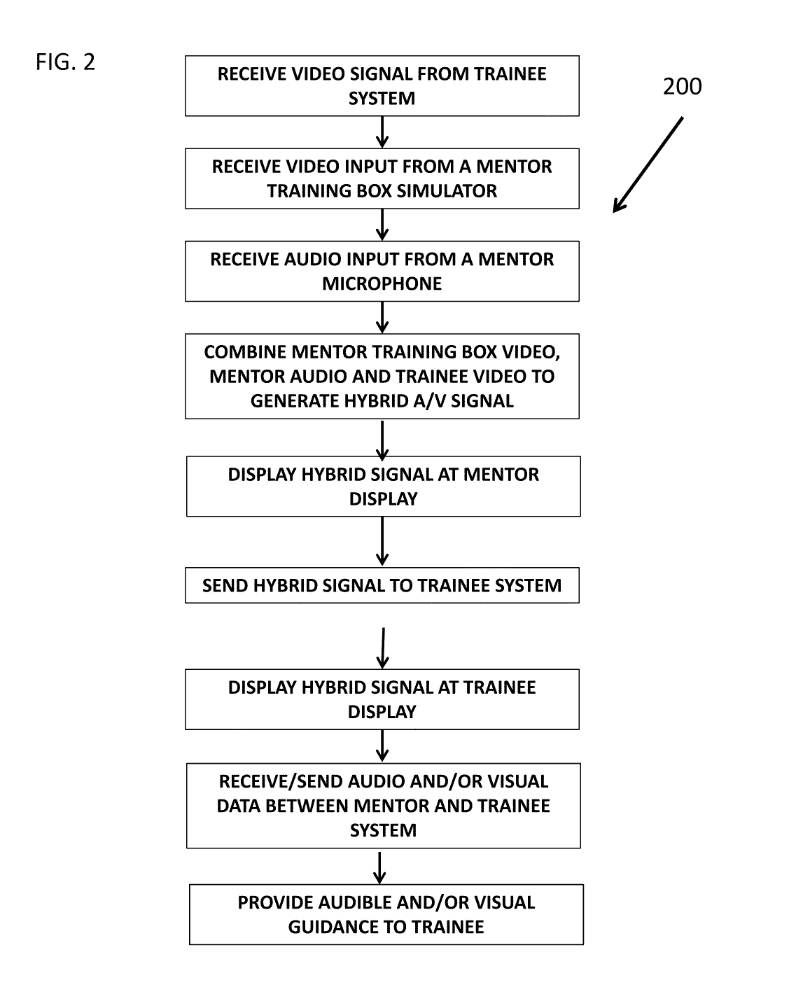

FIG. 2 provides a flow-chart illustrating an exemplary method of tele-mentoring. In some embodiments, methods for tele-mentoring include receiving a video signal from a trainee system in a trainee environment; receiving video input from a mentor training box simulator; receiving audio input from a mentor microphone; receiving audio input from a trainee microphone; combining the mentor training box video, and trainee video to generate hybrid visual signal; displaying the hybrid signal at a mentor display; sending the trainee audio signal to the mentor environment; sending the hybrid video signal and the mentor audio signal to the trainee environment for output at a trainee system display in the trainee environment.

In some examples, the method includes receiving/sending audio and visual data between the two systems to allow real-time audible and visual guidance to be provided.

In some embodiments, the method for tele-mentoring also comprises filtering the mentor training laparoscopic box video and trainee video prior to combining the mentor training lap box video and trainee video to generate a hybrid video signal. The filtering and processing of signals allows the clarity of the signals to be improved. In some embodiments, the method for tele-mentoring comprises filtering the mentor training lap box video by using chroma key compositing to remove the background color of the mentor box video signal. In some examples, the method uses green screen technology for superimposition of images/data.

It is contemplated that the disclosed method can be performed with the mentor environment being located at one room or location and the trainee environment being at a second room or location. For example, the method includes coupling the two environments by a network, such as a LAN, WAN or internet. In some examples, the method includes coupling the mentor environment to the trainee environment by a wireless communication network. In some examples, the method includes coupling the mentor environment to the trainee environment by a wired communication network. In some examples, the method includes coupling a mentor environment at a remote location such as an office or laboratory, with a trainee environment, such as an operating room, by a network, such as a wireless communication network.

In some examples, a disclosed system for tele-mentoring is used for tele-mentoring a laparoscopic procedure. Laparoscopy is an operation performed in the abdomen or pelvis through small incisions (usually 0.5-1.5 cm) with the aid of a capture device, such as a camera. Laparoscopy can either be used to inspect and diagnose a condition or to perform surgery. There are two types of laparoscopes: (1) a telescopic rod lens system that is usually connected to a video camera (single chip or three chip), and (2) a digital laparoscope where the charge-coupled device is placed at the end of the laparoscope, eliminating the rod lens system. It is contemplated that the disclosed system may be used for tele-mentoring a laparoscopic procedure with either type of laparoscope. For example, the video signal, whether analog or digital, is captured post-conversion by the laparoscopic video tower. This signal can be fed via either analog or digital means.

In some examples, an exemplary tele-mentoring system for laparoscopic procedure training includes a mentor environment (labeled Mobile Mentor) and a trainee environment (labeled OR (operating room)). In a particular example, the mentor environment includes an augmented reality tele-mentoring (ART) platform with a simulator, such as a portable laparoscopic training box simulator, and an A/V processor/filter/mixer. The ART platform includes green-screen technology and a camera so that the entire image captured by the portable laparoscopic training box simulator's camera has a green screen background. Laparoscopic instruments identical to those being used in the hypothetical operating room are introduced into the simulator box and during mentoring are operated as normal (e.g., as used by the surgeon if performing the operation or simulated operation). The training environment includes a trainee system with two laparoscopic trainee instruments and an image device, which allows the trainee instruments and surrounding image field to be provided to the mentor environment. Additionally, a trainee microphone is coupled to the trainee system and a trainee display is coupled to the mentor environment to result in a tele-mentoring system which allows an image of the mentor instructional laparoscopic instruments to be superimposed on the trainee laparoscopic instruments allowing a mentor to provide real-time audible and visual guidance to a trainee during the laparoscopic procedure.

In use, a video signal produced by the laparoscopic box simulator is combined with the audio signal from a properly positioned microphone and fed into an audio/video filter, processor, and mixer. Simultaneously, the video signal from the laparoscopic video tower and audio from a properly positioned microphone in the operating room are fed into the same audio/video filter, processor and mixer. This signal is transmitted, such as by either a wired or wireless connection, to the ART platform. Both signals are then filtered to improve clarity, and processed. The signal from the mentor laparoscopic training box is processed using chroma key compositing to remove the background color and superimposed onto the video feed from the operating room to create a hybrid image. This output image includes the live intraoperative video with mentor instrument images, or “ghost” instruments that are controlled by the surgical mentor. This video output is then transmitted with audio to both the operating room and tele-mentor platform via either wireless or wired connection. This method allows the learner to be mentored remotely both visually and audibly, using instruments identical to those being used by the learner to perform the procedure and expert techniques being demonstrated in real-time by the tele-mentor to both clearly and reliably guide the learner in a technically challenging arena.

### III. Exemplary Computing Environment

The techniques and solutions described herein can be performed by software, hardware, or both, of a computing environment, such as one or more computing devices. For example, computing devices include server computers, desktop computers, laptop computers, notebook computers, handheld devices, netbooks, tablet devices, mobile devices, PDAs, and other types of computing devices.

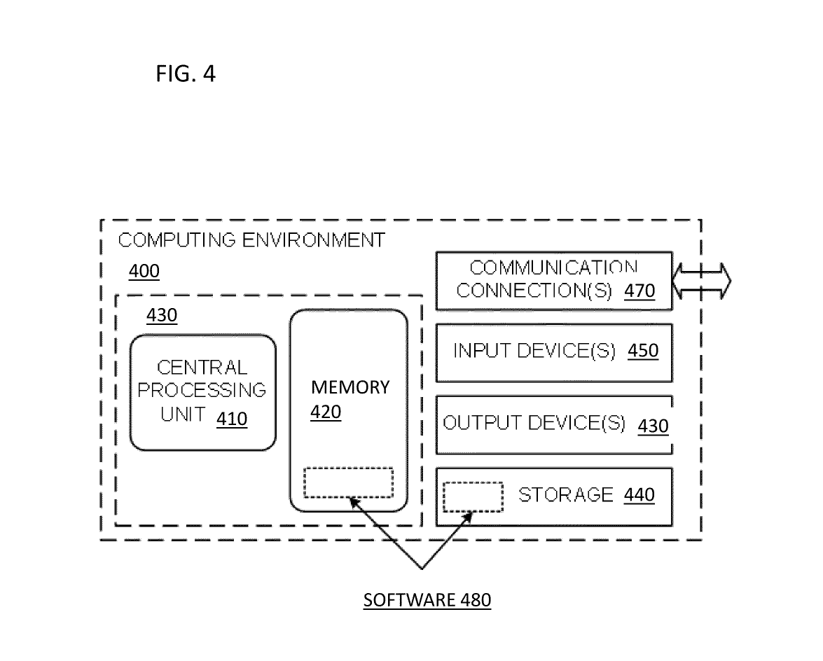

FIG. 4 illustrates a generalized example of a suitable computing environment 400 in which the described technologies can be implemented. The computing environment 400 is not intended to suggest any limitation as to scope of use or functionality, as the technologies may be implemented in diverse general-purpose or special-purpose computing environments. For example, the disclosed technology may be implemented using a computing device comprising a processing unit, memory, and storage, storing computer-executable instructions implementing methods disclosed herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like. The disclosed technology may also be practiced in distributed computing environments where tasks are performed by remote processing devices that are linked through a communications network. In a distributed computing environment, program modules may be located in both local and remote memory storage devices

With reference to FIG. 4, the computing environment 400 includes at least one processing unit 410 coupled to memory 420. In FIG. 4, this basic configuration 430 is included within a dashed line. The processing unit 410 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. The memory 420 can store software 480 implementing any of the technologies described herein.

A computing environment may have additional features. For example, the computing environment 400 includes storage 440, one or more input devices 450, one or more output devices 460, and one or more communication connections 470. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 440 may be removable or non-removable, and includes magnetic disks, magnetic tapes or cassettes, CD-ROMs, CD-RWs, DVDs, or any other computer-readable media which can be used to store information and which can be accessed within the computing environment 400. The storage 440 can store software 480 containing instructions for any of the technologies described herein.

The input device(s) 450 may be a touch input device such as a keyboard, mouse, pen, or trackball, a voice input device, a scanning device, or another device that provides input to the computing environment 400. For audio, the input device(s) 450 may be a sound card or similar device that accepts audio input in analog or digital form, or a CD-ROM reader that provides audio samples to the computing environment. The output device(s) 460 may be a display, printer, speaker, CD-writer, or another device that provides output from the computing environment 400.

The communication connection(s) 470 enable communication over a communication mechanism to another computing entity. The communication mechanism conveys information such as computer-executable instructions, audio/video or other information, or other data. By way of example, and not limitation, communication mechanisms include wired or wireless techniques implemented with an electrical, optical, RF, infrared, acoustic, or other carrier.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### IV. Methods in Computer-Readable Media

Any of the disclosed methods can be implemented as computer-executable instructions or a computer program product stored on one or more computer-readable storage media (e.g., non-transitory computer-readable media, such as one or more optical media discs such as DVD or CD, volatile memory components (such as DRAM or SRAM, or non-volatile memory components such as hard drives) and executed on a computer (e.g., any commercially available computer, including smart phones or other mobile devices that include computing hardware). Computer-readable media does not include propagated signals. Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the internet, a wide-area network, a local-area network, a client-server network (such as a cloud computing network), or other such network using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash or any other suitable programming language. Likewise, the disclosed technology is not limited to any particular computer or type of hardware. Certain details of suitable computers and hardware are well known in the art and need not be set forth in detail in this disclosure.

Furthermore, any of the software-based embodiments (comprising, for example, computer-executable instructions for causing a computer to perform any of the disclosed methods) can be uploaded, downloaded or remotely accessed through a suitable communication means. Such suitable communication means include, for example, the internet, the World Wide Web, an intranet, cable (including fiber optic cable), magnetic communications, electromagnetic communications (including RF, microwave, and infrared communications), electronic communications, or other such communication means.

### Example

This example provides a randomized controlled trial using a disclosed ART platform to assess the efficacy of a new surgical education technology.

Laparoscopic skills training has evolved over recent years. However, conveying a mentor's directions using conventional methods, without realistic on-screen visual cues, can be difficult and confusing. To facilitate laparoscopic skill transference, an ART Platform was designed to overlay the instruments of a mentor onto the trainee's laparoscopic monitor. The aim of this Example was to compare the effectiveness of this new teaching modality to traditional methods in novices performing an intra-corporeal suturing task.

Laparoscopy requires the development of specialized psychomotor skills which are most effectively learned with hands-on practice and feedback. The fidelity of feedback is equally important to the quantity of hands-on practice. This is the theory behind augmented reality simulators that provide haptic feedback along with the use of authentic surgical instruments, visual cues and objective assessment. However, simulators are most effective when, in addition to the above features, a mentor is involved in training, specific goals are outlined, and complete surgical procedure simulations are used.

Simulators have even been shown to bring trainees' skills past the level of the learning curve for laparoscopic procedures, yet mentoring remains advantageous and supervised hands-on training is still required. Even results of complex laparoscopic surgeries have been shown to be equivalent between mentored trainees and expert surgeons. Technological advances have allowed for the advent of telemedicine, and tele-mentoring with telestrating has been shown to be as effective as on-site mentoring during laparoscopic surgical skills training using a virtual reality simulator. Additionally, tele-mentoring has been shown to increase the quality and availability of laparoscopic surgery. Tele-mentoring and telestrating can be beneficial for training surgeons in more advanced techniques and provide accessibility to remote locations or community hospitals while decreasing travel costs for patients, mentees and mentors. However, the expense of telemedicine systems, their installation, maintenance and broadband services may outweigh this cost savings, especially if patient volume is low.

Increased time restrictions on residents' working hours, increased patient load of attending surgeons, and increased operating room costs make it necessary to develop a more efficient hands-on training technique. While augmented reality simulators are suggested to be superior to and preferred over virtual reality simulators by expert surgeons and trainees, they also have been shown to improve surgical skills and may reduce the learning curve for laparoscopic training. Augmented reality has also been used in the operating room to provide 3D image overlay of anatomical structures resulting in increased surgical precision in laparoscopy. However, with the obvious utility of augmented reality it has yet to be used in the operating room as a training aid.

Methods and Procedures:

19 pre-medical and medical students (MS1 & MS2) were randomized into traditional mentoring (n=9) and ART (n=10) groups for a laparoscopic suturing and knot-tying task. Subjects received either traditional mentoring or ART for one hour on the validated Fundamentals of Laparoscopic Surgery (FLS) Intra-corporeal Suturing Task. As all subjects were novices and had no previous laparoscopic experience, they were informed they were taking part in a study regarding laparoscopic training, and blinded to whether they were in the experimental or control group. Sample size was determined by an a-prior statistical power calculator for t test with a Cohen's d of 0.8, 0.05 as probability, and with a power of 0.8. As all subjects were novices, they were oriented by being required to complete the FLS Peg Transfer Task within 96 seconds for two consecutive trials. Once this goal was attained they were no longer allowed to practice. All subjects returned within ten days of initial training to perform the experimental portion of the study. All subjects were oriented to the instruments and watched the FLS video in which the suturing task was explained and demonstrated. Requirements for the task included: placing a suture through two dots on a longitudinally slit Penrose drain, tying the knot tightly enough to close the slit, refraining from avulsing the drain off the block and finishing with three square throws.

Subjects were randomly assigned to one of two groups. The control group (n=9) was instructed verbally in-person by an expert with the ability of the trainer to point to the screen. The experimental group (n=10) was taught by an expert using the ART platform. Both groups were instructed by the trainer in a standardized step-by-step manner using only verbal cues derived from a predefined script. The subjects were required to complete each suture after their initial needle placement. Subjects and trainers were in continual visual and audio contact.

The time for each suture task was recorded (beginning when both instruments were seen on the screen and finishing when both sutures were cut). If the drain was avulsed or the drain was torn to the surface, the task was recorded at maximal time limit (10 minutes). Each millimeter the needle insertion was away from the dots was counted as one error. Air knots, insecure knots and small tears were also counted as errors. Each error was given a five second time penalty which was added to the trial's suture time.

Each subject completed 10 suture attempts or as many attempts as could be completed within one hour in order to avoid fatigue. All attempts were video recorded.

After the experimental group completed their training they were asked to complete a questionnaire regarding their opinion on seven aspects of their experience using the ART platform. Results were analyzed using means, standard deviation, power regression analysis, correlation coefficient, analysis of variance, and student's t-test.

The tele-mentoring system used in this study for laparoscopic procedure training included a mentor environment (labeled Mobile Mentor) and a trainee environment (labeled OR (operating room)). In this particular example, the mentor environment included an augmented ART platform with a simulator, such as a portable laparoscopic training box simulator, and an A/V processor/filter/mixer. The ART platform included chroma key technology and a camera so that the entire image captured by the portable laparoscopic training box simulator's camera has a green screen background. Laparoscopic instruments identical to those being used in the hypothetical operating room were introduced into the simulator box and during mentoring were operated as usual (e.g., as used by the surgeon if performing the task). The training environment included a trainee system with two laparoscopic trainee instruments and an image device which allowed the trainee instruments and surrounding image field to be provided to the mentor environment. Additionally, a trainee microphone was coupled to the trainee system and a trainee display was coupled to the mentor environment to result in a tele-mentoring system which allowed an image of the mentor instructional laparoscopic instruments to be superimposed on the trainee's monitor allowing a mentor to provide real-time audio and visual guidance to a trainee during the laparoscopic procedure.

Results and Conclusions:

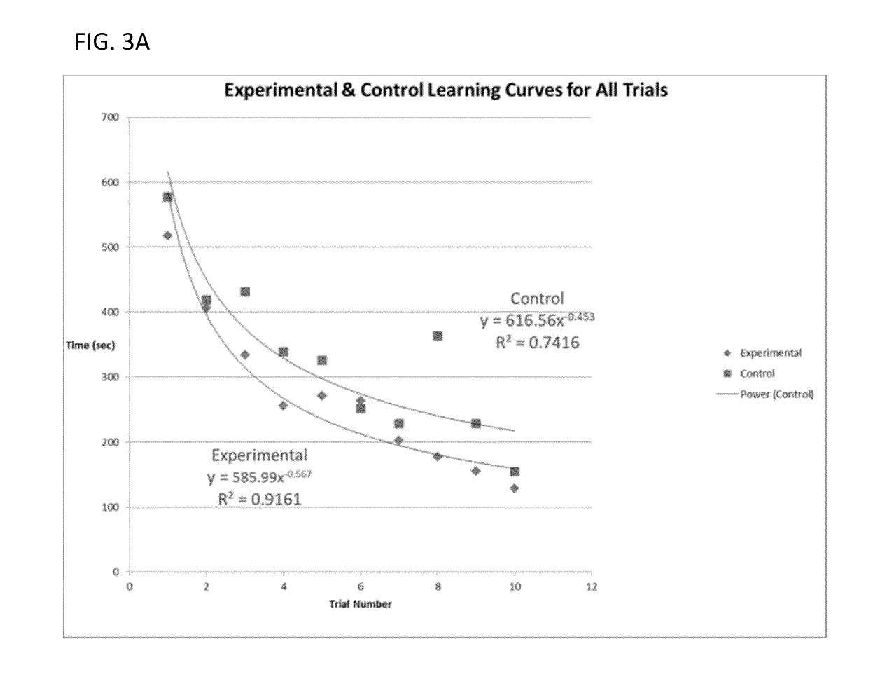

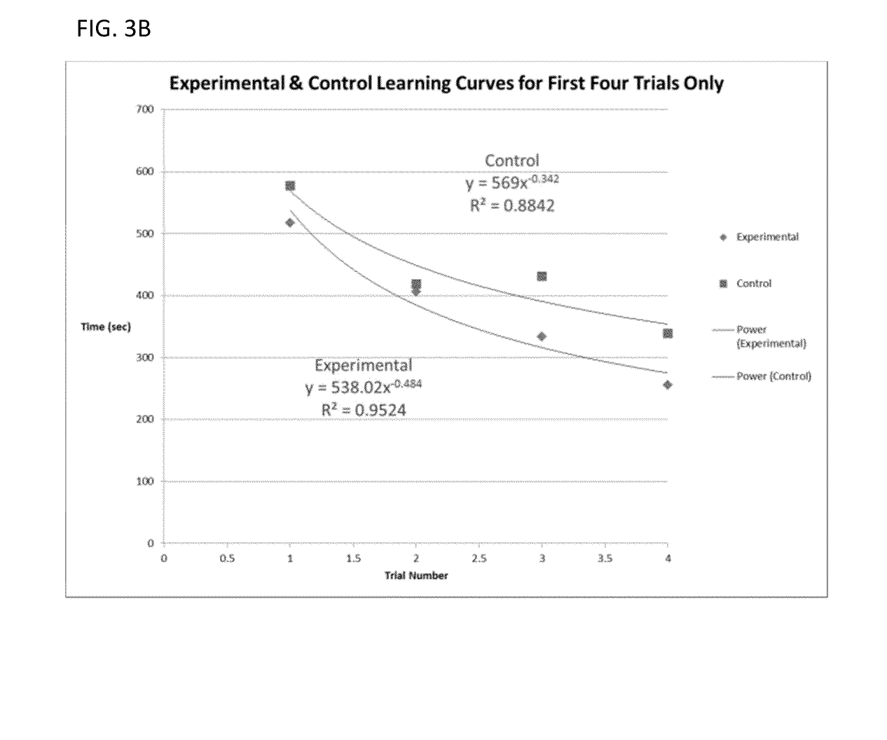

18 participants completed the trial, one subject did not complete the trial according to guidelines due to noncompliance. Using Wright's Cumulative Average Model (Y=a×b) the learning curve slope (FIG. 3A) was significantly steeper, demonstrating faster skill acquisition, for the ART group (b=−0.567, r2=0.92) than the control group (b=−0.453, r2=0.74). This difference was greater during the first 4 trials (FIG. 3B) with ART having faster skill acquisition vs. traditional training (b=−0.484, r2=0.88 vs. b=−0.342, r2=0.95). At the end of 10 repetitions or one hour of practice the ART group was faster vs. traditional training (mean 167.4 s vs. 242.4 s, p=0.014). The ART group also had fewer fails than the traditional group. The surveys showed eight of the ten subjects agreed or strongly agreed that “the ART Platform is an effective mentoring device.”

Currently, the standard of laparoscopic surgical education includes observing procedures, practicing on virtual or augmented reality trainers, and finally, hands-on practice in the operating room with a mentor verbally guiding the trainee. The advent of tele-mentoring has shown to be able to expand the use of laparoscopic surgery which is often preferred to open surgery by patients and physicians because of the cosmetic results, decreased post-surgical pain, shorter hospital stay, and quicker return to normal bowel movements. However there are still limitations with current tele-mentoring devices especially in more advanced procedures and with more inexperienced surgeons. In routine practice, the use of augmented reality to overlay an expert's surgical instruments onto the trainee's surgical view (Augmented Reality Tele-mentoring) may reduce the need for mentors to take over the instruments during surgery, therefore allowing for increased hands-on practice by trainees, decrease operating time, and in turn, decreasing expenses. Additionally, while current telestrating techniques allow for a mentor to draw illustrations over the mentees surgical view, the use of actual instruments overlaid on the mentee's monitor will bypass the need for artistic skill on the mentor's part and improve understanding and clarity of the desired positioning and maneuvers. The ART platform allows the learner to be mentored remotely both visually and audibly, using instruments identical to those being used by the learner to perform the procedure and expert techniques being demonstrated in real-time by the telementor to both clearly and reliably guide the learner in a technically challenging arena. These aspects allow for real time demonstration and lead-and-follow training which produces high fidelity immediate feedback for the trainee resulting in a steeper learning curve and faster procedure times.

The disclosed ART platform is a more effective training technique in teaching laparoscopic skills to novices compared to traditional methods. ART training produced faster skill acquisition in a validated intracorporeal suturing task. This difference was greatest in the first four trials. ART training reduced the number of failed attempts and resulted in faster suture times by the end of the training session. The disclosed studies indicate that Augmented Reality Tele-mentoring may be a more effective training tool in laparoscopic surgical training for complex tasks than traditional methods.

### DEFINITIONS

As used in this application and in the claims, the singular forms “a,” “an,” and “the” include the plural forms unless the context clearly dictates otherwise. Similarly, the word “or” is intended to include “and” unless the context clearly indicates otherwise. The term “comprising” means “including;” hence, “comprising A or B” means including A or B, as well as A and B together. Additionally, the term “includes” means “comprises.”

Additionally, the description sometimes uses terms like “produce” and “provide” to describe the disclosed methods. These terms are high-level abstractions of the actual computer operations that are performed. The actual computer operations that correspond to these terms will vary depending on the particular implementation and are readily discernible by one of ordinary skill in the art.

### Alternatives

The disclosed methods, apparatuses and systems should not be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A tele-mentoring system, comprising:
a mentor environment, comprising:
a mentor training laparoscopic box simulator comprising a mentor camera and mentor laparoscopic instruments;
a mentor computing device comprising an audio/visual (A/V) processor, the computing device being coupled to the mentor training laparoscopic box simulator;
a mentor microphone coupled to the computing device; and
a mentor display coupled to at least the computing device, thereby
forming a mentor environment; and
a trainee environment, comprising:
a trainee system comprising trainee laparoscopic instruments and trainee camera coupled to the mentor computing system;
a trainee microphone coupled to the trainee system and the mentor computing device; and
a trainee display coupled to the mentor environment thereby forming a tele-mentoring system for use in mentoring trainees to perform laparoscopic procedures, wherein the mentor environment is coupled to the trainee environment so that video generated by the mentor camera is superimposed on video generated by the trainee camera to allow for generation of a hybrid video signal comprising both the trainee laparoscopic instruments and the mentor laparoscopic instruments, which is provided, along with the mentor audio signal to the trainee display, to provide real-time audible and visual guidance to a trainee.

2. The tele-mentoring system of claim 1, wherein the trainee camera and mentor camera are oriented in the same position so that superimposing their images yields a hybrid video image to facilitate real-time visual guidance to the trainee.

3. The tele-mentoring system of claim 1, wherein the mentor environment is portable/mobile.

4. The tele-mentoring system of claim 1, wherein the mentor environment is at a remote location.

5. The tele-mentoring system of claim 1, wherein the mentor environment is coupled to the trainee environment by a network, such as a Local Area Network (LAN), Wide Area Network (WAN) or the internet.

6. The tele-mentoring system of claim 1, wherein the mentor environment is coupled to the trainee environment by a wireless communication network.

7. The tele-mentoring system of claim 1, wherein the mentor environment is coupled to the trainee environment by a wired communication network.

8. The tele-mentoring system of claim 1, wherein the mentor environment uses green screen technology for superimposition of images/data.

9. The tele-mentoring system of claim 1, wherein the mentor laparoscopic training box further comprises chroma key compositing to remove the background color of the video generated by the mentor camera.

10. The tele-mentoring system of claim 1, wherein the computing device further comprises a filter for filtering at least the video generated by the mentor camera and a signal mixer for creating a hybrid image from the video generated by the trainee camera and the video generated by the mentor camera.

11. A method for tele-mentoring, comprising:
receiving a trainee video signal from a trainee system;
receiving a mentor video signal from a mentor training box simulator;
receiving a mentor audio signal from a mentor microphone;
generating a hybrid video signal based on the mentor video signal and the trainee video signal to generate a hybrid video signal;
displaying the hybrid video signal at a mentor display;
sending the hybrid video signal and the audio signal to the trainee system; and
wherein the combining and the sending occurs in real time to allow for real-time audible and visual guidance of a trainee by its mentor is facilitated.

12. The method of claim 11, wherein the mentor video signal comprises an image of mentor instruments with a background having substantially uniform background color.

13. The method of claim 12, wherein the generating comprises: removing the background color of the mentor video signal using chroma key compositing to generate a filtered mentor video signal, and combining the filtered mentor video signal to the trainee video signal to generate the hybrid video signal.

14. The method for tele-mentoring of claim 11, wherein the method is a method for tele-mentoring for a laparoscopic procedure.

15. The method for tele-mentoring of claim 14, wherein the mentor training box simulator comprises laparoscopic instructional instruments.

16. The method for tele-mentoring of claim 11, wherein the mentor training box simulator is portable/mobile.

17. The method for tele-mentoring of claim 11, wherein the mentor training box is at a remote location.

18. The method for tele-mentoring of claim 11, wherein the mentor training box simulator is coupled to the trainee system by a network, such as a Local Area Network (LAN), Wide Area Network (WAN) or an internet.

19. The method for tele-mentoring of claim 11, wherein the mentor training box simulator is coupled to the trainee system by a wireless communication network.

20. The method for tele-mentoring of claim 11, further comprising filtering the mentor training box video and trainee video prior to combining the mentor training box video and trainee video to generate hybrid signal.
